(19) United States
(12) Patent Application Publication
(10) Pub. No.: US 2012/0215953 A1
(43) Pub. Date: Aug. 23, 2012

(54) LARGE-KEY NUMERIC KEYPAD

(76) Inventor: Jack E. Kosmach, Duluth, MN (US)

(21) Appl. No.: 13/068,874

(22) Filed: Dec. 28, 2010

(51) Int. Cl. G06F 13/12; H01H 13/14

(52) U.S. Cl. 710/67; 200/341

(57) ABSTRACT

A large-key numeric keypad includes large keys with bold, easy-to-read lettering for increased visibility and contrast.

### SUMMARY

In general terms, this disclosure is directed to a large-key numeric keypad.

### BRIEF DESCRIPTION OF THE DRAWINGS

FIG. 1 is a perspective view of an embodiment of the large-key numeric keypad.

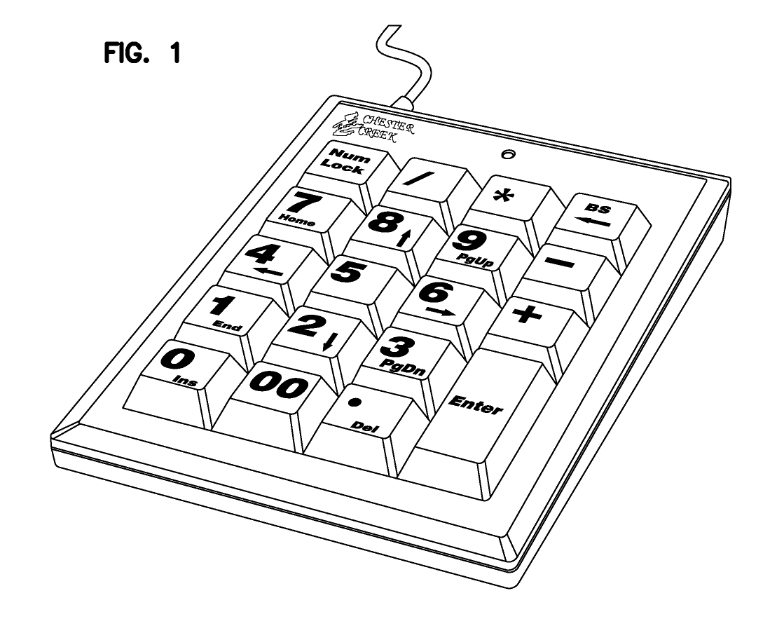

### DETAILED DESCRIPTION

Various embodiments will be described in detail with reference to the drawing. Reference to various embodiments does not limit the scope of the claims attached hereto. Additionally, any examples set forth in this specification are not intended to be limiting and merely set forth some of the many possible embodiments for the appended claims.

CHESTER CREEK™ Innovative keyboards and mice for all ages and abilities

Children|Seniors|Assistive Technology|Teachers|Keyboards|Mice|Accessories

Chester Numeric KeyPad

Nineteen keys that could change your life . . . or at least make it a little easier.

For many people using a standard keypad is simply not possible because of vision and/or dexterity issues. The Chester Creek numeric keypad is the ONLY large-key numeric keypad that makes it a little easier for anyone to crunch numbers like a pro—with large, 1″ keys with bold, easy-to-read lettering for increased visibility and contrast.

The Chester Keypad works well with all Chester Creek large-key keyboards, and has all the features of a typical keypad including the / key for division, and the * key for multiplication, o and oo keys, and a subtle click to confirm each keystroke.

With a plug-and-play USB connector, there's no need to worry about installing drivers, making it easy to use and very practical. The keypad has all the features of a typical keypad, including the / key for division and the * key for multiplication, o and oo keys.

Compatible with Windows Accessibility “Mouse Keys” to allow use of the keypad for mouse navigation, which is especially helpful for people who cannot, or prefer not to use a mouse.

Mouse Keys is software that converts the numeric keypad into a directional mouse. When activated, each number on the numeric keypad controls a direction for the mouse or cursor. For example, pressing the 6-key on the numeric keypad directs the mouse to the “right”. Pressing the 9-key directs the mouse “up & to the right”. Etc. Other keys on the numeric keypad have the functions found with the traditional mouse such as; single click, and drag-lock and settings allow for adjusting the acceleration and speed of onscreen mouse.

Specifications:

Large 1″ square keys

Large easy to read print

USB connector

All the features of a typical keypad including:

/-key for division function

-key for multiplication function

Compatible with Windows Accessibility “Mouse Keys” to allow use of the keypad for mouse navigation for people who cannot or prefer not to use a mouse.

205 W. 2^{nd} Street, suite 130, Duluth, Minn. 55802 USA 888-214-5450 www.chestercreek.com CPSIA RoHS Compliant

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A keypad comprising:
a plurality of data entry keys, each key having indicia printed thereon, at least some of the indicia including the numbers from 0 to 9 arranged in at least three rows, wherein the data entry keys have a width and a depth of greater than about 0.75 inches.

2. The keypad of claim 1, wherein the width and the depth are greater than 0.75 inches.

3. The keypad of claim 1, wherein the width and the depth are at least about one inch.

4. The keypad of claim 3, wherein the width and the depth are at least one inch.

5. The keypad of claim 1, wherein the keys including the numbers from 0 to 9 have a square profile.

6. The keypad of claim 1, wherein a first row includes the numbers 7, 8, and 9.

7. The keypad of claim 6, wherein the first row further includes a minus symbol.

8. The keypad of claim 6, wherein a second row includes the numbers 4, 5, and 7.

9. The keypad of claim 8, wherein the second row further includes the plus symbol.

10. The keypad of claim 8, wherein a third row includes the numbers 1, 2, and 3.

11. The keypad of claim 10, wherein the third row further includes at least a portion of an enter key.

12. The keypad of claim 10, wherein a fourth row includes the number 0.

13. The keypad of claim 12, wherein the fourth row further includes a double zero (“00”), a period, and at least a portion of an enter key.

14. The keypad of claim 12, further comprising a non-numerical key row including a num lock key, a division symbol, a multiplication symbol, and a back space key.

15. The keypad of claim 1, further comprising a base, wherein the base has a tapered configuration such that a height of the rear of the keypad base is greater than a height of the front of the keypad base.

16. A method of using a numeric keypad, the method comprising:
coupling a numeric keypad to a computing device, the computing device including at least a processor and memory, the memory storing instructions that are executable by the processor to perform processing operations;
receiving an input into the numeric keypad, the numeric keypad having enlarged keys; and
communicating a signal to the computing device, the signal identifying at least one key of the numeric keypad to permit the computing device to determine the at least one key of the numeric keypad selected by the input.

17. The method of claim 16, wherein coupling the keypad to the computing device comprises connecting a cable to a USB port of the computing device.

18. The method of claim 16, wherein coupling the keypad to the computing device comprises communicating with the computing device through wireless communication devices selected from a Bluetooth device, an IEEE 802.11-type device, a radio frequency communication device, and an infrared communication device.

19. A numeric keypad as illustrated and described herein.

20. Any of the systems or methods illustrated or described herein.
